(19) United States
(12) Patent Application Publication
(10) Pub. No.: US 2017/0158320 A1
(43) Pub. Date: Jun. 8, 2017

(54) UNMANNED AERIAL SYSTEM

(71) Applicant: Daniel Bosch, San Diego, CA (US)

(72) Inventor: Daniel Bosch, San Diego, CA (US)

(21) Appl. No.: 15/269,314

(22) Filed: Sep. 19, 2016

Related U.S. Application Data
(60) Provisional application No. 62/221,025, filed on Sep. 20, 2015.

(51) Int. Cl. B64C 27/52; B64C 15/12; B64D 27/24; B64C 27/08; B64C 27/02; B64C 39/02; B64D 47/08

(52) U.S. Cl. CPC B64C 27/52; B64C 39/024; B64C 15/12; B64D 47/08; B64C 27/08; B64C 27/02; B64D 27/24; B64C 2201/042; B64D 2221/00

(57) ABSTRACT

A multi-propeller unmanned aerial system (UAS) with a wind-resistant software platform that allows for motor support arm rotation, thereby allowing two propellers to move the drone forward and backward, or rotate it, through thrust vectoring, while the other propellers maintain hover. Horizontal movement is possible without losing the level stability necessary for a number of drone-related functions such as aerial photography. The software platform of the UAS provides for the rotational movement of the motor support arm and motors to engage and disengage to allow for tiltrotor control, specifically two motors rotate to advance the UAS forward or reverse while the remaining propellers maintain hover. Propeller guards are provided for safety which do not affect the maximum thrust or flight maneuverability of the drone.

### CROSS REFERENCE TO RELATED APPLICATIONS

This utility patent application claims the benefit of U.S. Prov. Pat. App. No. 62/221,025, filed Sep. 20, 2015, the entirety of which is hereby incorporated by reference.

### BACKGROUND OF THE INVENTION

### Field of the Invention

This invention relates to the general field of aerial, self-propelled vehicles, and more specifically, to a multi-propeller drone that can perform well in windy and rainy conditions. The drone is controlled by an advanced, “wind resistant” software platform and an embedded flight control system attached to the structure of the drone and controlled by servo or motor movement. The software and hardware jointly controls, through thrust vectoring, one or more propellers that can be rotated through motor support arm rotation, thereby allowing two propellers to move the drone forward and backward, or rotate it, through thrust vectoring, while the other propellers maintain hover.

This allows the drone to move instantaneously in any direction desired without losing the level stability necessary for a number of drone-related functions such as aerial photography and other common drone uses. Because of the efficiency of the configuration, the drone has superior performance under conditions of high wind and can resist weather conditions that can “down” traditional drones. The drone also has rain-resistant aircraft skin, giving it further protection from adverse weather conditions. The drone also provides propeller guards for safety which do not affect the maximum thrust or flight maneuverability of the drone.

The field of unmanned aerial systems, or “drones” is growing rapidly. There are a number of system applications for drones, including agriculture, security, real estate, entertainment or general videography, inspections, construction, search and rescue, surveillance and military operations.

An unmanned aerial vehicle (UAV) or unmanned aerial system (UAS), commonly known as a drone and referred to as a Remotely Piloted Aircraft (RPA) by the International Civil Aviation Organization (ICAO), is an aircraft without a human pilot aboard. Its flight is controlled either autonomously by onboard computers or by the remote control of a pilot on the ground or in another vehicle. The typical launch and recovery method of an unmanned aircraft is by the function of an automatic system or an external operator on the ground. Historically, UAVs were simple remotely piloted aircraft, but autonomous control is increasingly being employed.

However, as drones developed, it became clear that there were a number of deficiencies in their design and function. For example, the common quad-, hex- and octocopters currently used by both hobbyists and professional drone pilots generally require that the drone “tilt” in order to move horizontally. This requires a gimbal or some other means by which a camera or other payload can be stabilized.

Other problems included the fact that drones generally perform poorly in windy conditions, and that rain generally “grounds” drones. In windy conditions, most drones will spend a large amount of their battery power just trying to maintain a level hover. Since most drone motors are exposed to the elements, a single drop of rain can short circuit a motor and cause an expensive and potentially dangerous drone to crash to the ground.

The prior art has several examples of attempts to resolve the problem of directional control. Tilt-rotor aerial vehicles are well known and used both in military (e.g., Bell/Boeing V-22 Osprey) and in civilian applications (Bell Augusta BA-609). As is known to those skilled in design of such vehicles, they suffer from various deficiencies, such as aeroelastic instability limiting their maximum speed, poor hover efficiency, excessive vibrations and larger noise levels due to large prop-rotors. A significant flaw of course is their single failure point design which unfortunately has meant many lost lives for operators and military members that have flown in the Osprey. In the UAS field the deficiencies are far less and thus, a tilt-rotor function is more feasible and practical on small unmanned aircraft.

Thrust vectoring, also referred to as thrust vector control or TVC, is the ability of an aircraft, rocket, or other vehicle to manipulate the direction of the thrust from its engine(s) or motor in order to control the attitude or angular velocity of the vehicle. In rocketry and ballistic missiles that fly outside the atmosphere, aerodynamic control surfaces are ineffective, so thrust vectoring is the primary means of attitude control. For aircraft, the method was originally envisaged to provide upward vertical thrust as a means to give aircraft vertical or short takeoff and landing (VTOL and STOL, respectively) ability. Subsequently, it was realized that using vectored thrust in combat situations enabled aircraft to perform various maneuvers not available to conventional-engine planes. To perform turns, aircraft that use no thrust vectoring must rely on the fixed direction thrust of a propeller and aerodynamic control surfaces only, such as ailerons or elevator; craft with vectoring may still require the use control surfaces, but to a lesser extent.

A multi-copter, also called a multirotor helicopter, quad, hex, octo rotors are common multirotor helicopters that are lifted and propelled by four, six or eight rotors. For wording reduction purposes, this invention description will focus on hexcopters. Hexcopters are classified as rotorcraft, as opposed to fixed-wing aircraft, because their lift is generated by a set of rotors (vertically oriented propellers). Unlike most helicopters, hexcopters use 3 sets of identical fixed pitched propellers; 3 clockwise (CW) and 3 counter-clockwise (CCW). These use variation of revolutions per minute (RPM) to control lift and torque. Control of vehicle motion is achieved by altering the rotation rate of one or more rotor discs, thereby changing its torque load and thrust/lift characteristics. Early in the history of flight, hexcopter configurations were seen as possible solutions to some of the persistent problems in vertical flight; torque-induced control issues (as well as efficiency issues originating from the tail rotor, which generates no useful lift) can be eliminated by counter-rotation and the relatively short blades are much easier to construct. A number of manned designs appeared in the 1920s and 1930s. These vehicles were among the first successful heavier-than-air vertical takeoff and landing (VTOL) vehicles. However, early prototypes suffered from poor performance, and latter prototypes required too much pilot work load, due to poor stability augmentation and limited control authority. More recently quad/hex/octocopter designs have become popular in unmanned aerial vehicle (UAV) research. These vehicles use an electronic control system and electronic sensors to stabilize the aircraft. With their small size and agile maneuverability, these hexcopters can be flown indoors as well as outdoors. There are several advantages to hexcopters over comparably-scaled helicopters. First, hexcopters do not require mechanical linkages to vary the rotor blade pitch angle as they spin. This simplifies the design and maintenance of the vehicle. Second, the use of six rotors allows each individual rotor to have a smaller diameter than the equivalent helicopter rotor, allowing them to possess less kinetic energy during flight. This reduces the damage caused should the rotors hit anything. For small-scale UAVs, this makes the vehicles safer for close interaction. Some small-scale hexcopters have frames that enclose the rotors, permitting flights through more challenging environments, with lower risk of damaging the vehicle or its surroundings.

UAS Systems can be optimized for numerous missions such as detect and evade system, search & rescue, surveillance, live feed, infrared, thermal, “Valley View”, conceptualize and document potential human movement recognition, adaptable delivery robotic arms for delivery of goods, search & scan areas, detach from base unit and deploy, transport payloads and live transmission of location to customer.

Thus there has existed a long-felt need for a weather-resistant drone that can perform in both windy and rainy conditions, and can effectively utilize a limited battery life to fly a desired course in a stable and efficient manner.

The current disclosure provides just such a solution by having a multi-propeller drone with an advanced, “wind resistant” software platform that allows the drone to move in any desired directly through the tiling of rotor arms, such that two propellers control the horizontal movements of the drone while four or more propellers control the vertical movements or hovering as the need may be. An embedded flight control system is attached to the body of the drone and controls the propellers through servo or motor movement. This allows the drone to move instantaneously in any direction desired without losing the level stability necessary for the drone to function efficiently. Because of the efficiency of the configuration, the drone has superior performance under conditions of high wind and can resist weather conditions that can “down” traditional drones. The drone also has rain-resistant aircraft skin, giving it further protection from adverse weather conditions. Finally, the drone also provides propeller guards for safety which do not affect the maximum thrust or flight maneuverability of the drone.

### OBJECTS OF THE INVENTION

It is therefore an object of the present invention to provide a drone with at least two rotating propellers.

Another object of the invention is to provide a drone that can hover and move laterally at the same time.

A further object of the invention is to provide a drone that can change position through thrust vectoring.

Another object of the invention is to provide propeller guards that do not affect maximum thrust or flight maneuverability.

A further object of the invention is to provide a wind-resistant drone.

Another object of the invention is to provide a weather-resistant drone.

An additional object of the invention is to provide a drone that can maneuver in an efficient manner through having two sets of propellers which are not in the same plane.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

One preferred form of the invention will now be described with reference to the accompanying drawings.

FIG. 1 is a perspective view of an unmanned aerial system according to selected embodiments of the current disclosure.

FIG. 2 is a perspective view of another unmanned aerial system according to selected embodiments of the current disclosure.

FIG. 3 is a front elevation view of an unmanned aerial system according to selected embodiments of the current disclosure.

FIG. 4A is a top plan view and FIG. 4B is a bottom plan view of an unmanned aerial system according to selected embodiments of the current disclosure.

FIG. 5A is a front elevation view and FIG. 5B is a back elevation view of an unmanned aerial system according to selected embodiments of the current disclosure.

FIG. 6 is a top plan view of a propeller guard according to selected embodiments of the current disclosure.

FIG. 7 is a bottom plan view of an unmanned aerial system according to selected embodiments of the current disclosure.

FIG. 8A is an exploded front elevation view and FIG. 8B is an exploded back elevation view of an unmanned aerial system according to selected embodiments of the current disclosure.

FIG. 9 is a top plan view of various unmanned aerial systems according to selected embodiments of the current disclosure.

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

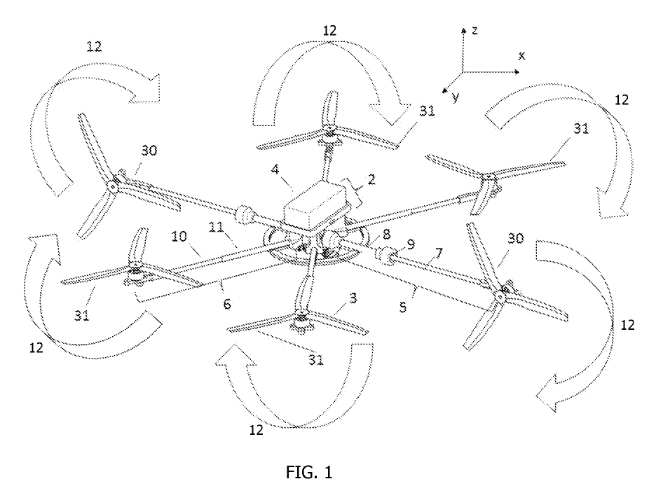

FIG. 1 is a perspective view of an unmanned aerial system according to selected embodiments of the current disclosure. The unmanned aerial vehicle includes six rotors 31, two of which are rotated ninety (90) degrees. The hex design can be optimal for a wide range of jobs requiring payloads of five to one-hundred pounds or more, flying at speeds in excess of one-hundred miles per hour and having flight times exceeding forty-five minutes with a Lithium Ion battery power source and much longer flight times with power sources such as solar, hydrogen or helium3 depending on propeller and total UAS volume and mission requirements. This rotating propeller and multi-system attached design can be any number of rotors and the multi-system can be attached to fixed wing aircraft as well.

The unmanned aerial system includes a base 2 that has a battery compartment 4 for storing one or more batteries or other power sources. The base 2 has four fixed arms 6 and two rotating arms 5 extending therefrom. The fixed arms 6 include an inner arm 11 and an outer arm 10 that connect the fixed rotor 31 to the base 2. The rotating arms 5 include a rotational housing 9 affixed to the end of an inner arm extension 8. An outer arm extension 7 secures a rotational rotor 30 to the rotational housing 9, whereby the outer arm extension 7 and corresponding rotor 30 can rotate about an axis extending along the length of the outer arm extension 7. Each fixed rotor 31 and rotational rotor 30 includes a propeller 3. Directional arrows 12 show the direction of rotation of each propeller 3.

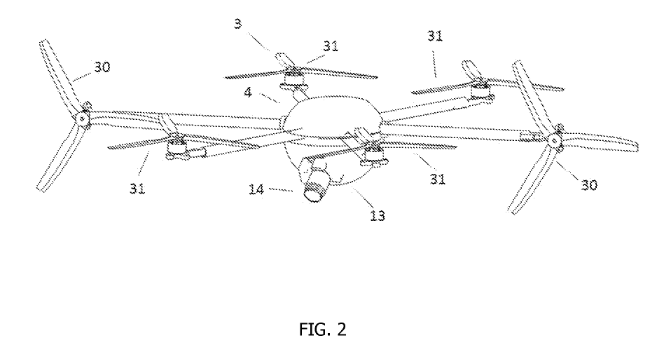

FIG. 2 is a perspective view of another unmanned aerial system according to selected embodiments of the current disclosure. The base of the unmanned aerial system includes a base bottom section 13. The base bottom section 13 has a camera 14 for capture still or video images. The batter compartment 4 is located on the top side of the base of the unmanned aerial system.

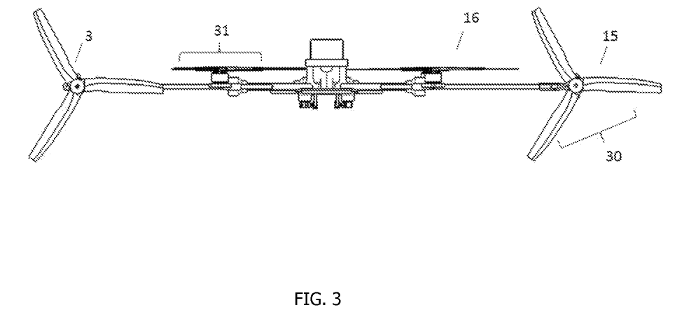

FIG. 3 is a front elevation view of an unmanned aerial system according to selected embodiments of the current disclosure. The rotational rotors 30 are in a vertical configuration, while the fixed rotors 31 are fixed in a horizontal 16 position.

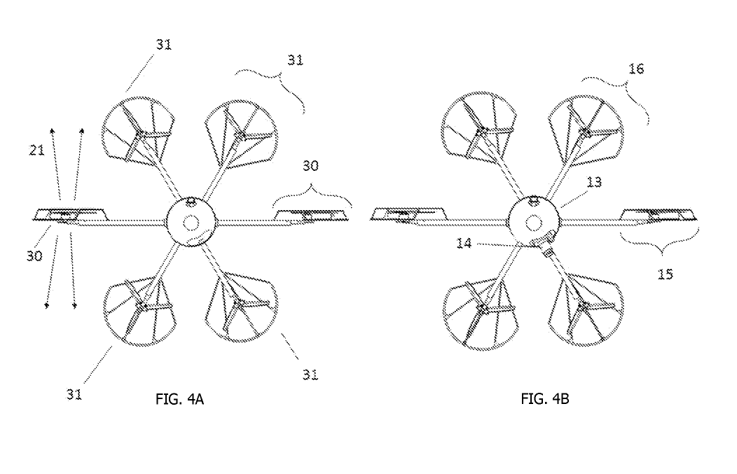

FIG. 4A is a top plan view of the unmanned aerial system with rotational rotors 30 in a vertical configuration. Thrust 21 provided by rotational rotors is perpendicular to the thrust produced by the fixed rotors 31. FIG. 4B is a bottom plan view of the unmanned aerial system showing the camera 14 of the base bottom section 13.

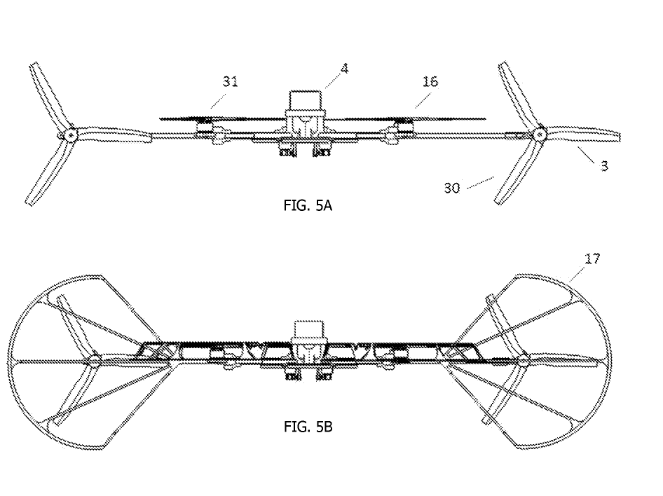

FIG. 5A is a front view of an unmanned aerial system without propeller guards. FIG. 5B is a front view of an unmanned aerial system with propeller guards 17 that protect the propellers 3 of the fixed rotors 31 and rotational rotors 30.

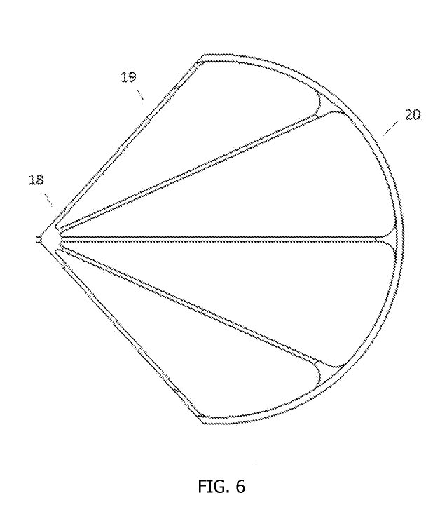

FIG. 6 is a top plan view of a propeller guard according to selected embodiments of the current disclosure. The propeller guard has a guard base connector 18 to which struts 19 are connected. The struts 19 support the outer line 20, which in combination protect the propeller from coming in contact with external objects while allow air flow (and thus, thrust) to flow therethrough.

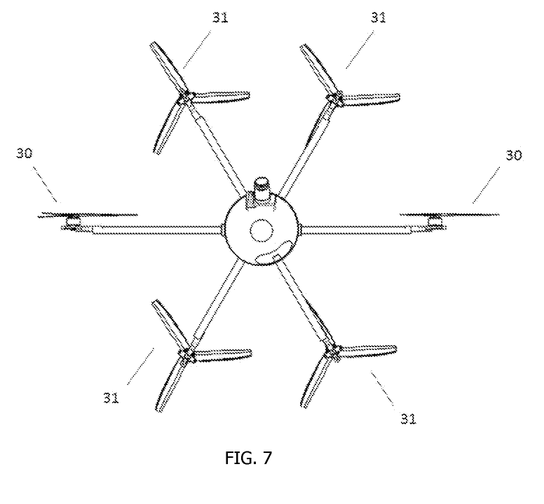

FIG. 7 is a bottom plan view of an unmanned aerial system according to selected embodiments of the current disclosure. The unmanned aerial system includes six rotors: four fixed rotors 31 and two rotational rotors 30.

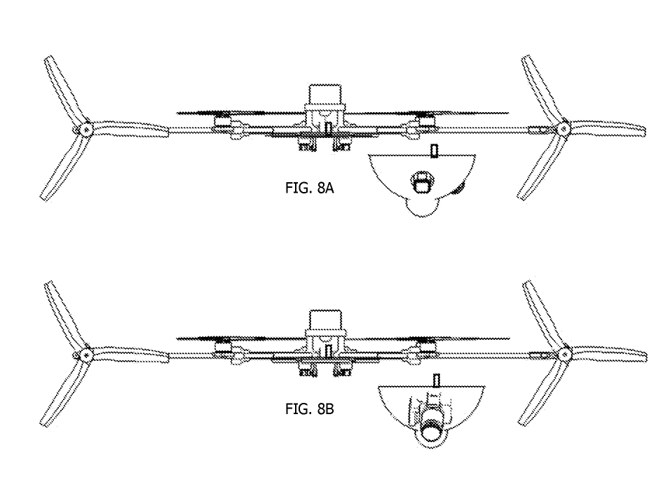

FIG. 8A is a back exploded view of an unmanned aerial system; FIG. 8B is a front view of an unmanned aerial system.

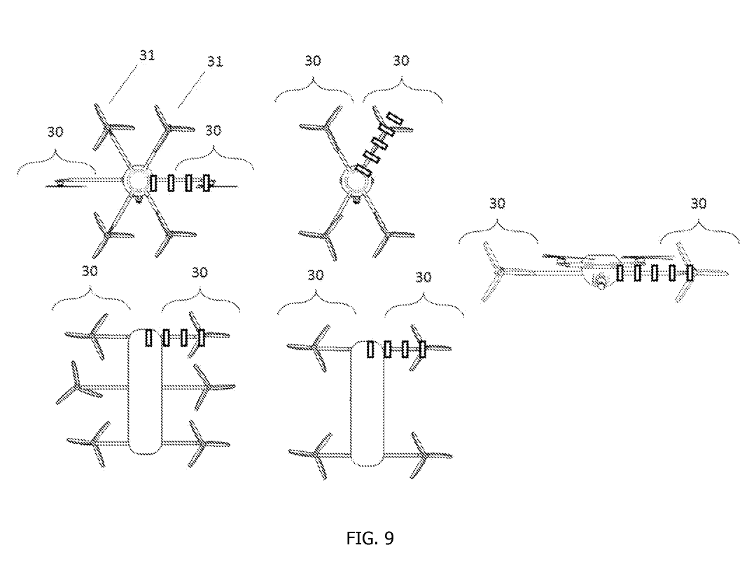

FIG. 9 is a top plan view of various unmanned aerial systems according to selected embodiments of the current disclosure.

The preceding figures show an unmanned aerial vehicle in a hex, or six rotor, configuration; however, this same rotating propeller design also applies to quad, octo or any number of propeller or thrust producing components, including jet-type engines.

A multi and changing secure signal configuration uses signal converters on both ends of transmitting signals from a controller or ground station and converting that signal on the UAS itself to accommodate a secure frequency approved by the FCC and according to the frequency allocation of the radio spectrum set forth by the FCC. The drone manually or automatically, via software, detects and actively switches signals to maintain a secure frequency channel for flight data, system data and video or radio signal required for mission configuration.

Prior art drones or UAVs are generally not capable of spinning on a fixed axis in space, connectable and configurable to individual, multi-unit and multi-platform use, for example a hover configuration converted to fixed wing. Prior art systems also are not generally propelled in any direction (that is, 360 degrees) due to the typical “helicopter” setup, with the propulsion capability downward or to the sides, giving the object about 180 degrees of freedom when looking at the propulsion capability. Furthermore, prior art systems are not generally designed to connect easily with each other and do not have ability to charge via solar and regenerated power by a system similar to those installed in motorized vehicles.

Flight capability of the UAS according to embodiments of the current disclosure is in any direction due to propelling devices/propellers on both sides of the system enabling it to move, flip and rotate on a single axis whilst maintaining stable flight at the same altitude or on that same x, y or z axis. The control systems utilized by the unmanned aerial system enables the drone to flip, move and stop unlike any other unmanned aerial system. This system enables easy connection while on the ground or in the air enabling the connected drones to work together for enhanced flight capability's such as speed and maneuverability and also to carry higher payloads. Such a configuration will use power splitters and reversing power in the electric motor to create self-sustaining energy. A sequence where the drone essentially free falls and uses wind power to recharge itself will be part of its programming.

Existing helicopter-type drone designs typically require three or more rotors for stability and the design is considered generally dynamically unstable. Single or Dual “Osprey” type designs are highly complex for UAS, offer only a single failure point type design and are very costly if made to commercial or military requirements. Single and dual rotor design are unfeasible for most commercial drone requirements and operation involving job tasks like inspection and agricultural crop health mapping. True downward thrust and flipping capability is only achieved by the most experienced stunt pilots and rotation on the same axis is virtually unachievable unless the propellers or rotors are rotatable. Flipping and complex maneuvers and flight and hover stability in many weather conditions are now possible with this invention.

In typical propeller systems, downward movement is only achieved by slowing the propellers or changing the angle of the propellers. With this system, where a plurality of rotors can rotate three-hundred-sixty degrees, downward movement/propelling is achieved also by the rotation and directional thrust in addition to traditional landing methods enabling landing in complex landing operations, including moving objects such as automobiles, trucks, boats, ships and ground based drones in the military and those built by the John Deer Co.

The stability and movements in any degree of direction in an instantaneous-like propulsion with this mechanical system can be achieved by multiple rotor systems acting in symmetry or independently, with symmetry being mirrored over the midpoint of the drone.

If upper propeller system fails, lower takes over.

During a flipping movement or sequence, the upper and lower propeller systems complement each other to allow optimal aerodynamic stability during flip sequence.

If counter rotating propellers are used one on top of the other on each UAS arm, for flight during up or down movements the opposite propulsion system turns off while the propulsion system (upper or lower) required to move the object adjusts according to the controls of the user and or auto-piloting software. Entire propulsion system is controlled by a flight controller on board UAS.

The drone according to particular embodiments of the current disclosure uses Arduino, but may use any software architecture that provides for for optimal flight capability and supports all movements and motor controls during flight and while connecting to brother/sister drones.

This UAS according to selected embodiments of the current disclosure is built via conventional manufacturing methods used to create aerospace grade components from titanium, aluminum, carbon fiber and other materials. The electrical motors are built by existing manufacturers. The assembly is also accomplished through traditional methods of assembling mechanical and electrical components.

Selected embodiments of the current disclosure include additional elements, such as electrical regenerative power system and solar panels. To achieve adequate flight times for recreational or commercial use, additional sources of power are useful.

The UAS can be flown with the body, one upper propeller, wireless receiver/controller, motors, battery and software loaded. The enhancements come with the counter rotating propellers, flaps/ailerons, symmetric lower propeller system, Regenerative Power System via solar, propeller braking, altitude drops, propeller momentum or wind.

Embodiments of the UAS disclosed herein are able to maneuver through tighter spaces and avoid obstacles easier compared to typical prior art drones. It can connect to other devices and drones to carry higher payloads and enhance flight capability's while performing acts such as taking video, pictures, carrying and delivering different size objects from one location to another.

Beyond drones/UASs, embodiments of the current disclosure may be implemented in manned flight vehicles transporting passengers or cargo and requiring the enhanced maneuverability that this system provides. The utility of this flight system can be implemented into nano-sized flight vehicles and nano-rechargeable devices all the way to full size military and commercial passenger sized flight vehicles.

While the foregoing written description of the invention enables one of ordinary aircraft operating, maintenance or engineering type skills and knowledge to make and use such an unmanned aerial system, those of ordinary aircraft operating, maintenance or engineering type skills and knowledge will understand and appreciate the existence of variations, combinations, and equivalents of the specific embodiments, methods and examples herein. The invention should therefore not be limited by the above described embodiments, methods, and examples, but by all embodiments and methods within the scope and spirit of the invention.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

That which is claimed:

1. An unmanned aerial system comprising
a base,
four fixed arms,
two rotating arms, and
six rotor systems;
where one end of each fixed arm is connected to the base and the other end is connected to one of the rotor systems, where one end of each rotating arm is connected to the base and the other end is connected to one of the rotor systems;
where each rotor system comprises a motor, a propeller, and a propeller guard, where the propeller guard comprises a base connector, a plurality of struts, and an outer line, where the struts secure the outer line to the base connector;
where each rotating arm comprises an inner arm, an outer arm, and a rotational housing, where the rotational housing rotationally secures the inner arm to the outer arm, whereby the outer arm rotates relative to the inner arm; and
where the base comprises a battery compartment, where the battery compartment comprises a battery.

2. The unmanned aerial system of claim 1, wherein the base further comprises a camera.

3. The unmanned aerial system of claim 1, wherein each fixed arm comprises an inner arm and an outer arm, where the inner arm is connected to the base, and where the outer arm is connected to one of the rotor systems.

4. The unmanned aerial system of claim 1, wherein the base further comprises a control system, where the control system controls the speed at which each rotor system operates, and where the control system controls the rotation of each rotating arm.

5. An vehicle comprising
a base,
a plurality fixed arms,
a plurality of rotating arms, and
a plurality of rotor systems;
where one end of each fixed arm is connected to the base and the other end is connected to one of the rotor systems, where one end of each rotating arm is connected to the base and the other end is connected to one of the rotor systems,
where each rotor system comprises a motor and a propeller,
where each rotating arm comprises an inner arm, an outer arm, and a rotational housing, where the rotational housing rotationally secures the inner arm to the outer arm, whereby the outer arm rotates relative to the inner arm.

6. The vehicle of claim 5, wherein each rotor system further comprises a propeller guard, where the propeller guard comprises a base connector, a plurality of struts, and an outer line, where the struts secure the outer line to the base connector.

7. The vehicle of claim 5, wherein the base comprises a battery compartment, where the battery compartment comprises a battery.

8. The vehicle of claim 7, wherein the base further comprises a regenerative power system, where the regenerative power system provides power to the battery compartment.

9. The vehicle of claim 8, wherein the regenerative power system obtains power from autorotation of one or more of the rotor systems.

10. The vehicle of claim 5, wherein the base further comprises a camera.

11. The vehicle of claim 5, wherein each fixed arm comprises an inner arm and an outer arm, where the inner arm is connected to the base, and where the outer arm is connected to one of the rotor systems.

12. The vehicle of claim 5, wherein the base further comprises a control system, where the control system controls the speed at which each rotor system operates, and where the control system controls the rotation of each rotating arm.

13. The vehicle of claim 5, wherein the vehicle comprises four fixed arms.

14. The vehicle of claim 5, wherein the vehicle comprises six fixed arms.

15. The vehicle of claim 5, wherein the vehicle comprises two rotating arms.

16. A method of operating an aerial vehicle, where the aerial vehicle comprises a base, a plurality fixed arms, a plurality of rotating arms, and a plurality of rotor systems; where one end of each fixed arm is connected to the base and the other end is connected to one of the rotor systems, where one end of each rotating arm is connected to the base and the other end is connected to one of the rotor systems, where each rotor system comprises a motor and a propeller, where each rotating arm comprises an inner arm, an outer arm, and a rotational housing, where the rotational housing rotationally secures the inner arm to the outer arm, whereby the outer arm rotates relative to the inner arm;
the method comprising the steps of:
rotating the propellers of the rotor systems connected to the fixed arms to provide lift to the aerial vehicle;
rotating each of the outer arms of the rotating arms; and
rotating the propellers of the rotor systems connected to the rotating arms to provide thrust to the aerial vehicle thereby causing it to move in a particular direction.

17. The method of claim 16, further comprising the step of rotating the propellers of the rotor systems connected to the rotating arms at different rotational velocities thereby causing the aerial vehicle to rotate about a vertical axis.

18. The method of claim 16, wherein the base comprises a battery compartment and a regenerative power system, where the battery compartment comprises a battery.

19. The method of claim 18, further comprising the step of allowing one or more of the rotor systems to auto-rotate whereby power is transferred from the rotor system to the regenerative power system, and then to the battery.

20. The method of claim 6, wherein each rotor system further comprises a propeller guard, where the propeller guard comprises a base connector, a plurality of struts, and an outer line, where the struts secure the outer line to the base connector.
